(19) United States
(12) Patent Application Publication
(10) Pub. No.: US 2025/0010304 A1
(43) Pub. Date: Jan. 9, 2025

(54) DEVICES, SYSTEMS, AND METHODS FOR NUCLEIC ACID AMPLIFICATION

(71) Applicant: LEX DIAGNOSTICS LTD., Royston (GB)

(72) Inventors: Amaru Daniel Araya-Williams, Cambridge (GB); Charlie Edward Constable, Cambridge (GB); Justin Rorke Buckland, Comberton (GB)

(21) Appl. No.: 18/711,396

(22) PCT Filed: Nov. 16, 2022
(86) PCT No.: PCT/EP22/82111

§ 371 Date: May 17, 2024

Related U.S. Application Data
(60) Provisional application No. 63/280,298, filed on Nov. 17, 2021.

(51) Int. Cl. B01L 3/00; B01F 33/452; B01F 101/23

(52) U.S. Cl. CPC B01L 3/523; B01F 33/452; B01F 2101/23; B01L 2200/025; B01L 2200/0684; B01L 2200/12; B01L 2200/16; B01L 2300/042; B01L 2300/161

(57) ABSTRACT

A reaction cartridge system is described herein. In some embodiments, a reaction cartridge, includes a cap that contains a lyophilized reagent cake within the cap, and a stirrer element encapsulated within the lyophilized reagent cake.

### CROSS REFERENCE TO RELATED APPLICATIONS

This application claims priority to U.S. Provisional Application No. 63/280,298 filed on Nov. 17, 2021, the entire contents of which are hereby incorporated by reference.

### BACKGROUND

Within the field of molecular biology, nucleic acid amplification has wide applicability in diagnostics, therapeutics, forensics, and research. One method of achieving nucleic acid amplification is by generating amplicons using the Polymerase Chain Reaction (PCR). Generally, amplicons are generated from a template using one or more primers, where the amplicons are homologous or complementary to the template from which they were generated. Normally, PCR methods rely on thermal cycling, which exposes reagents (e.g., primers and polymerase) to repeated cycles of heating and cooling to permit different temperature-dependent reactions to occur within an individual reaction receptacle. Typically, a PCR reaction is a three-step reaction including a denaturation step, an annealing step, and an extension step. The duration of each reaction step can be between 15 seconds and 90 seconds, and the three reaction steps can be repeated for a number of cycles, generally between 25 and 40 iterations of the three-step reactions. Thus, the duration of known PCR reactions can take multiple hours to complete.

Thermal cycling can include heating and cooling elements to increase and decrease the temperature of a PCR reaction. PCR can be expensive and time consuming. The volume of PCR reactions are typically between 25 μl and 50 μl. These large volume reactions can be expensive to operate due to the cost of the reagents and time spent in preparation. Automated PCR systems can decrease time spent in preparation, but can give inconsistent results due to problems such as inconsistent mixing of reagents and impediments such as bubbles. Magnetic stir elements have been implemented in PCR reactions that include large reagent volumes to provide consistent mixing.

### SUMMARY

This disclosure features improved devices, systems, and methods for nucleic acid amplification using a reaction cartridge with a cap and a stirrer element encapsulated in lyophilized reagents. In use, the cap is coupled or attached to a base to create a mixing chamber with an inlet channel and an outlet channel that provide a path for liquid (e.g., reagents) to be filled into the mixing chamber and to be subsequently removed from the mixing chamber. The reaction cartridge includes improvements to nucleic acid amplification by permitting fast and consistent mixing of the lyophilized reagents, via the stirrer element, upon rehydration. This configuration allows preparation of small volumes of reagents that can otherwise be difficult to mix. In this way, efficient and consistent mixing of a decreased reaction volume can conserve time and reagents.

Also disclosed are improvements to devices, systems, and methods for nucleic acid amplification using the mixing chamber inlet channel configured to fill the mixing chamber with liquid before the liquid reaches the outlet channel. These improvements trap gas bubbles and keep them away from the reaction chamber, which, in turn, increases reaction efficiency and facilitates consistent and fast heating and cooling. In some embodiments, the gas is trapped in the mixing chamber to avoid gas entering into the reaction chamber.

In another aspect, this disclosure provides reaction cartridges, including a cap, with a lyophilized reagent cake within the cap, and a stirrer element encapsulated within the lyophilized reagent cake.

In some embodiments, the stirrer element includes a magnet or a material that is capable of being magnetized or a material that retains magnetic properties. In some embodiments, the stirrer element is arranged within the cap to rotate when exposed to a time-varying external magnetic field. In some embodiments, the stirrer element is arranged within the cap to rotate along an internal perimeter of the cap when exposed to a time-varying external magnetic field.

In some embodiments, the lyophilized reagent cake is hydrophilic. In some embodiments, the lyophilized reagent cake is porous. In some embodiments, the cap includes a convex wall. In some embodiments, the stirrer element is immobile when encapsulated within the lyophilized reagent cake. In some embodiments, the stirrer element is encapsulated within the lyophilized reagent cake aligned in a horizontal orientation with respect to the cap. In some embodiments, the stirrer element has a shape that is one of a cylinder or a rectangular prism.

Also disclosed herein are reaction cartridges that include a base, including an inlet channel having an inlet opening positioned on a first planar surface of the base; and an outlet channel having an outlet opening positioned on a second planar surface of the base, wherein the first planar surface is positioned above the second planar surface when the reaction cartridge is in use; and the outlet channel and the inlet channel extend through the base.

In some embodiments, the inlet channel and outlet channel extend generally orthogonally with respect to the base. In some embodiments, the inlet opening of the inlet channel is configured to dispense liquid into a mixing chamber formed when the reaction cartridge is in use. In some embodiments, the first planar surface and the second planar surface form a step in the base separating the inlet opening and the outlet opening. In some embodiments, the step causes a liquid dispensed by the inlet channel into the mixing chamber to undergo a meniscus pinning effect. In some embodiments, the outlet channel is configured to remove gas from a mixing chamber formed when the reaction cartridge is in use. In some embodiments, the base is hydrophobic.

Also disclosed herein are reaction cartridge systems that include one or more caps, each cap including a lyophilized reagent cake; and a stirrer element encapsulated within the lyophilized reagent cake: a base, including one or more inlet channels having an inlet opening positioned on a first planar surface on the base; and one or more outlet channels having an outlet opening positioned on a second planar surface on the base, wherein the first planar surface is positioned above the second planar surface when the reaction cartridge system is in use: the one or more caps are coupled to the base to form one or more mixing chambers such that the lyophilized reagent cake of each cap of the one or more caps is positioned above a respective one or more inlet channels within the mixing chamber: the one or more outlet channels and the one or more inlet channels extend through the base; and prior to use, a reaction volume is enclosed within a hollow space of each of the one or more caps when the one or more caps are coupled to the base.

In some embodiments, the inlet channel and the outlet channel extend generally orthogonally with respect to the base of the one or more mixing chambers. In some embodiments, the one or more reaction cartridges are arranged on a pitch of about 0.5 mm to about 15 mm. In some embodiments, the one or more mixing chambers are arranged on a pitch of about 9 mm, or 4.5 mm, or 2.25 mm, or 1.125 mm. In some embodiments, a distance between the inlet opening of the one or more inlet channels and the lyophilized reagent cake within the cap is less than the capillary length of water. In some embodiments, a distance, L between the inlet opening and a lower surface of the lyophilized reagent cake is less than the capillary length λ_{C}, wherein λ_{C}=V (γ/(g (ρ_{L}−ρ_{G})))=2.7 mm, giving a Bond number: Bo= (g L²(ρ_{L}−ρ_{G}))/γ of less than 1 when calculated using liquid and gas properties of water and air at normal temperature and pressure (NTP), respectively, wherein λ_{C} is the capillary length, γ is the surface tension, g is gravitational acceleration, ρ_{L}−ρ_{G} are the density difference, and/is the characteristic length (i.e., distance L).

In some embodiments, the distance between the inlet opening of the one or more inlet channels and the lyophilized reagent cake within the cap is less than about 2.7 mm. In some embodiments, each of the one or more mixing chambers has a volume that is less than 50% of the cap volume. In some embodiments, the lyophilized reagent cake of each of the one or more caps comprises one or more reagents. In some embodiments, the one or more reagents are reagents for a polymerase chain reaction. In some embodiments, the lyophilized reagent cake of each of the one or more caps includes one or more differing reagents.

In some embodiments, one or more probes are included in the lyophilized reagent cake of each of the one or more caps. In some embodiments, each of the one or more probes correspond to a position of the respective one or more caps coupled to the one or more mixing chambers. In some embodiments, an excitation wavelength of each of the one or more probes is at a first wavelength. In some embodiments, an emission wavelength of each of the one or more probes is at a second emission wavelength. In some embodiments, the lyophilized reagent cake of each of the one or more caps includes a reference dye. In some embodiments, an excitation wavelength of the reference dye is at a different excitation wavelength than the excitation wavelength of the one or more probes. In some embodiments, an emission wavelength of the reference dye is at the same emission wavelength as the one or more probes. In some embodiments, the reference dye is visible at the same emission wavelength as the one or more probes when the one or more inlet channels fills their respective mixing chamber with liquid. In some embodiments, the reference dye is visible at the second same emission wavelength as the one or more probes when the lyophilized reagent cake is mixed with liquid from the one or more inlet channels. In some embodiments, the reference dye is ROX Reference Dye (glycine conjugate of 5-carboxy-X-rhodamine, succinimidyl ester).

In some embodiments, the one or more caps are made from a material that blocks light. In some embodiments, the lyophilized reagent cake is in the form of lyophilized beads. In some embodiments, the base further includes one or more alignment pins extending in a perpendicular orientation with respect to the base of each of the one or more mixing chambers. In some embodiments, the base further includes one or more attachment clips to couple to the one or more caps. In some embodiments, one or more driving magnets are positioned above or below the one or more caps in use.

In another embodiment, the disclosure provides methods of making a reaction cartridge. In some embodiments, the methods include a) adding one or more liquid reagents to one or more caps: b) adding a stirrer element to the one or more caps: c) aligning the stirrer element within the one or more liquid reagents; and d) lyophilizing the one or more liquid reagents, wherein lyophilizing the one or more liquid reagents generates a lyophilized reagent cake.

In some embodiments, the stirrer element is immobilized in the lyophilized reagent cake. In some embodiments, prior to step d), adding one or more primers and corresponding probes to each of the one or more caps. In some embodiments, the one or more primers and corresponding probes added to each of the one or more caps are different. In some embodiments, step c) includes applying a magnetic field in a direction substantially perpendicular to a height of the one or more caps. In some embodiments, prior to step d), further adding a reference dye to the one or more caps. In some embodiments, step a) occurs before step b). In some embodiments, step a) occurs after step b). In some embodiments, steps a) and b) occur at about the same time.

Also disclosed herein are methods of rehydrating a lyophilized reagent cake contained within a reaction cartridge, the methods including a) filling a plurality of mixing chambers with liquid via an inlet opening contained within each of the plurality of mixing chambers, wherein each of the plurality of mixing chambers is formed from a respective cap coupled to a base: b) allowing the liquid to rehydrate a lyophilized reagent cake contained within each of the plurality of mixing chambers, wherein a stirrer element is immobilized within the lyophilized reagent cake; and c) activating the stirrer element to move within each respective mixing chamber of the plurality of mixing chambers.

In some embodiments, the liquid includes a biological sample. In some embodiments, the lyophilized reagent cake comprises reagents for PCR. In some embodiments, activating the stirrer element includes applying a magnetic field to the stirrer element. In some embodiments, applying the magnetic field to the stirrer element causes the stirrer element to rotate. In some embodiments, applying the magnetic field to the stirrer element causes the stirrer element to move around the perimeter of the respective mixing chamber of the plurality of mixing chambers.

The configuration of the reaction cartridges described herein provides cost and resource conservation by spatial multiplexing. The different reactions are separated in different reaction chambers. As such, competition between reactions is eliminated, which simplifies the design of the assay. The design of the fluorescence detection hardware of the cartridge utilizes a single channel fluorescence for each of the reaction chamber detection systems rather than a single and more complex channel florescence system that detects all of the florescence for all of the reaction chambers. In this way, the same wavelength fluorophore can be used to detect multiple targets, because the results are determined by spatial multiplexing (e.g., based on the position of one or more mixing chambers on a common chassis) rather than by color-based multiplexing. Each spatially multiplexed reaction chamber has its own detection component (e.g., a photodiode). Illumination and optical filter components can be shared across reaction chambers or replicated for each reaction chamber.

In some embodiments, the lyophilized reagents can include a passive reference dye, which can increase efficiency and accuracy by alerting an invalid result (e.g., inadequate reagent delivery and/or inadequate mixing) rather than reporting a false negative. In this way, a user can troubleshoot and investigate the invalid result rather than inadvertently dismissing the results as a false negative.

The term “each,” when used in reference to a collection of items, is intended to identify an individual item in the collection, but does not necessarily refer to every item in the collection, unless expressly stated otherwise, or unless the context of the usage clearly indicates otherwise.

As used herein, the term “meniscus pinning” refers to the surface tension of a liquid at a geometric edge. In some embodiments, meniscus pinning is used to prevent movement of the solid-liquid-gas contact line, for example, when reaching a geometric edge.

As used herein, the term “phase-change material” refers to reagents (e.g., PCR reagents) that have been reduced from a liquid form to a compact dry form, which can then be rehydrated and dissolved in use.

As used herein, the term “lyophilized reagent cake” refers to reagents (e.g., PCR reagents) that have been lyophilized to transition from a liquid to a dry, solid mass, e.g., a disk, prism, cylinder, or cuboid, of reagents.

Where values are described in terms of ranges, it should be understood that the description includes the disclosure of all possible sub-ranges within such ranges, as well as specific numerical values that fall within such ranges irrespective of whether a specific numerical value or specific sub-range is expressly stated.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below: All publications, patent applications, patents, and other references mentioned herein are incorporated by reference in their entirety. In case of conflict, the present specification, including definitions, will control. In addition, the materials, methods, and examples are illustrative only and not intended to be limiting.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

Other features and advantages of the invention will be apparent from the following detailed description, and from the claims.

### DESCRIPTION OF DRAWINGS

The following drawings illustrate certain embodiments of the features and advantages of this disclosure. These embodiments are not intended to limit the scope of the appended claims in any manner. Like reference symbols in the drawings indicate like elements.

FIG. 1A is a schematic cross-section that shows a reaction cartridge including a chamber formed by a cap and a base as disclosed herein, where the base includes a fluid inlet and a fluid outlet.

FIG. 1B is a schematic diagram that shows an example of the mixing chamber of FIG. 1A with a stirrer element.

FIG. 2 is a schematic cross-section of a mixing chamber containing a magnetic stirrer element immobilized in a solid phase-change material and a magnetic driver head.

FIG. 3 is a three-quarter view representation of a reaction cartridge system with an array of four mixing chambers formed between a set of four caps attached to four bases.

FIG. 4A is a cross-sectional schematic diagram that shows a cap containing a stirrer element and reagents.

FIG. 4B is a cross-sectional schematic diagram that shows a cap containing a stirrer element immobilized in dried reagents that take up a smaller volume than the liquid reagents in FIG. 4A.

FIG. 4C is a cross-section schematic diagram of a cap containing a stirrer element immobilized in dried reagents turned upside down and attached to a base.

FIG. 5A is a schematic diagram of a magnetic alignment fixture to rotate magnetic stirrer elements into a horizontal orientation during manufacture of three sets of four reagent caps.

FIG. 5B is an image that shows the orientation of the alignment magnets of the magnetic alignment fixture shown in FIG. 5A.

FIG. 5C is a representation that shows three sets of four reagent caps containing stirrer elements being aligned by sliding the caps past an array of alignment magnets.

FIG. 6 is a flow chart of assembly steps to create a mixing chamber containing a stirrer element immobilized in a phase-change material.

FIG. 7A is a schematic top view of a reaction cartridge with two bases including a step feature.

FIG. 7B is a cross-section schematic of the base of FIG. 7A with the step feature, an inlet channel, and an outlet channel.

FIG. 8A is a schematic cross-section schematic that shows an initial state of reagent rehydration within a cap attached to a base.

FIG. 8B is a schematic cross-section schematic that shows a subsequent state of reagent rehydration with liquid introduced via an inlet channel within a cap attached to a base.

FIG. 8C is a schematic cross-section schematic that shows a subsequent state of reagent rehydration where the liquid has wetted part of the reagent within a cap attached to a base.

FIG. 8D is another schematic cross-sectional image that shows a subsequent state of reagent rehydration where the edge of the step feature has caused a meniscus pinning effect on the advancing liquid front.

FIG. 8E is another schematic cross-section schematic that shows a subsequent state of reagent rehydration where the reagent has been wetted within a cap attached to a base.

FIG. 8F is another schematic cross-section schematic that shows a subsequent state of reagent rehydration where the stirrer element is mixing the reagent within a cap attached to a base.

FIG. 8G is another schematic cross-section schematic that shows a subsequent state of reagent rehydration within a cap attached to a base when the reagent solution is expelled through an outlet channel.

FIG. 9 is a schematic diagram of one embodiment of a reaction cartridge as disclosed herein.

FIG. 10A is a representation of a user interface of a reaction cartridge as operating in a reader module.

FIG. 10B is a representation of an example of the simple steps of loading a reaction cartridge into a reader module, e.g., of FIG. 10A.

FIG. 10C shows a representation of PCR results on a user interface on the reader module, e.g., of FIG. 10A.

FIG. 11 is a flow chart showing a representative method of making a reaction cartridge as disclosed herein.

FIG. 12 is a flow chart showing a representative method of filling a mixing chamber to rehydrate reagents and mitigate bubbles, as disclosed herein.

FIG. 13 is a graph showing a figure of merit for cylindrical stirrer elements plotted against cylinder aspect ratio (length to diameter) in the range or about 1.15 to about 5.0 and subject to the constraint that the stirrer element can rotate within a 1 mm radius circle.

FIG. 14 is a graph that shows an example of a ratio (length to diameter) of a stirrer element with a narrowed range around the peak shown in FIG. 13.

FIG. 15 is a graph of a calculation of a numerical simulation of the difference in magnetic energy using COMSOL Multiphysics® software. The x-axis is a dimensionless ratio of the length of a cylinder/diameter of a cylinder. The y-axis is the difference in total magnetic energy in Joules between the case when a magnetic field is applied in a direction perpendicular to the axis of the cylinder and the case when a magnetic field is applied in a direction parallel to the axis of the cylinder.

### DETAILED DESCRIPTION

This disclosure recites PCR devices, systems, and methods that improve efficiency of reactions, e.g., PCR reactions, by implementing small reagent volumes and stirrer elements that achieve consistent mixing of reagents. In some embodiments, a reader module can accept a reaction cartridge that contains a chassis with one or more integrated bases to which one or more reagent caps can be coupled, e.g., an integrated set of four reagent caps, can be attached to form respective mixing chambers between the interior of the caps and the tops of the bases when coupled. Each of the caps can include reagents (e.g., PCR reagents) that can correspond to a specific target, such as a pathogen, e.g., a bacterial or viral pathogen. In general, targets can include any cells or microorganisms that include nucleic acid, e.g., RNA or DNA.

In general, a chassis of a cartridge can include one or more bases capable of accepting multiple caps, one cap per base, where each cap includes reagents that can detect the genetic material of a pathogen. In some examples, a stirrer element is encapsulated in lyophilized reagents contained in the cap, and upon rehydration the stirrer element can move via the application of an external magnetic force. Embodiments described herein can further include a base with a fluid inlet and fluid outlet that provide a meniscus pinning effect that can force the mixing chamber to fill before the fluid reaches the fluid outlet. In this way, small volume PCR reactions can be thoroughly mixed when rehydrated and the generation of bubbles is mitigated.

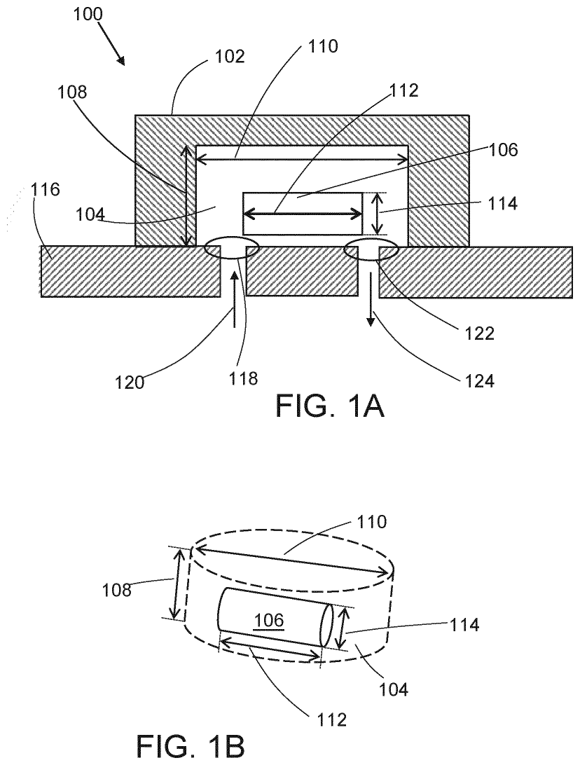

FIG. 1A shows a cross-section of a reaction cartridge including a mixing chamber 104 formed by a cap 102 and a base 116. The base 116 includes an inlet channel 120 having an inlet opening 118 and an outlet channel 124 having an outlet opening 122. The cap 102 contains a loose stirrer element 106 within the mixing chamber 104. In some embodiments, the cap 102 can include a convex wall. The convex wall can be the vertical wall between the surface of the inlet opening 118 and the outlet opening 122.

Stirrer element 106 can be of various shapes. For example, stirrer element 106 can be a cylinder, a cuboid, a disc, a pyramid, or an irregular geometric shape. In some embodiments, the stirrer element 106 is a cuboid. In some embodiments, the stirrer element 106 is a cylinder. In some embodiments, the stirrer element is a square cuboid. In some embodiments, the stirrer element is a rectangular cuboid. In some embodiments, the stirrer element is a square cross-section cuboid. In some embodiments, the stirrer element is a rectangular cross-section cuboid. The stirrer element 106 can have a stirrer length 112 of about 0.75 mm to about 6 mm. In some embodiments, the stirrer element 106 can have a stirrer length of about 0.75 mm to about 6 mm, about 1.0 mm to about 6 mm, about 1.25 mm to about 6 mm, about 1.50 mm to about 6 mm, about 1.75 mm to about 6 mm, about 2.00 mm to about 6 mm, about 2.25 mm to about 6 mm, about 2.50 mm to about 6 mm, about 2.75 mm to about 6 mm, about 3.00 mm to about 6 mm, about 3.25 mm to about 6 mm, about 3.50 mm to about 6 mm, about 3.75 mm to about 6 mm, about 4.00 mm to about 6 mm, about 4.25 mm to about 6 mm, about 4.50 mm to about 6 mm, about 4.75 mm to about 6 mm, about 5.00 mm to about 6 mm, about 5.25 mm to about 6 mm, about 5.50 mm to about 6 mm, or about 5.75 mm to about 6 mm. In some embodiments, the stirrer length is about 2.5 mm.

In some embodiments, when the stirrer element 106 has a diameter (e.g., a cylinder), the stirrer diameter 114 can be about 0.25 mm to about 3 mm. In some embodiments, the stirrer diameter 114 is about 0.25 mm to about 3 mm, about 0.50 mm to about 3 mm, about 0.75 mm to about 3 mm, about 1.0 mm to about 3 mm, about 1.25 mm to about 3 mm, about 1.50 mm to about 3 mm, about 1.75 mm to about 3 mm, about 2.00 mm to about 3 mm, about 2.25 mm to about 3 mm, about 2.50 mm to about 3 mm, or about 2.75 mm to about 3 mm. In some embodiments, the stirrer length 112 is greater than the stirrer diameter 114. In some embodiments, the stirrer element has a stirrer diameter of about 1.9 mm.

In some embodiments, the stirrer element has a length that is more than 25% of the diameter of the chamber. For example, in some embodiments, the stirrer element has a length that is about 25% to about 90% of the diameter of the chamber. In some embodiments, the stirrer element has a length that is about 25% of the diameter of the chamber. In some embodiments, the stirrer element has a length that is about 30% of the diameter of the chamber. In some embodiments, the stirrer element has a length that is about 35% of the diameter of the chamber. In some embodiments, the stirrer element has a length that is about 40% of the diameter of the chamber. In some embodiments, the stirrer element has a length that is about 45% of the diameter of the chamber. In some embodiments, the stirrer element has a length that is about 50% of the diameter of the chamber. In some embodiments, the stirrer element has a length that is about 55% of the diameter of the chamber. In some embodiments, the stirrer element has a length that is about 60% of the diameter of the chamber. In some embodiments, the stirrer element has a length that is about 65% of the diameter of the chamber. In some embodiments, the stirrer element has a length that is about 70% of the diameter of the chamber. In some embodiments, the stirrer element has a length that is about 75% of the diameter of the chamber. In some embodiments, the stirrer element has a length that is about 80% of the diameter of the chamber. In some embodiments, the stirrer element has a length that is about 85% of the diameter of the chamber. In some embodiments, the stirrer element has a length that is about 90% of the diameter of the chamber.

The stirrer element 106 can be made from a material capable of being magnetized or a material that retains magnetic properties. For example, a material that is capable of being magnetized can be a soft ferromagnetic material that can become magnetized in an external field, but does not retain the magnetization outside of the magnetic field. An example of material that retains magnetic properties can be a hard ferromagnetic material that can become magnetized in an external field and retains magnetic properties outside of the magnetic field. For example, the stirrer element 106 can be made from stainless steel or nickel. In some embodiments, the stirrer element 106 may be coated with a chemically inert substance such as glass or polytetrafluoroethylene. Non-limiting examples of stirrer elements 106 include those from V&P SCIENTIFIC™ (e.g., VP 716 and/or VP 717).

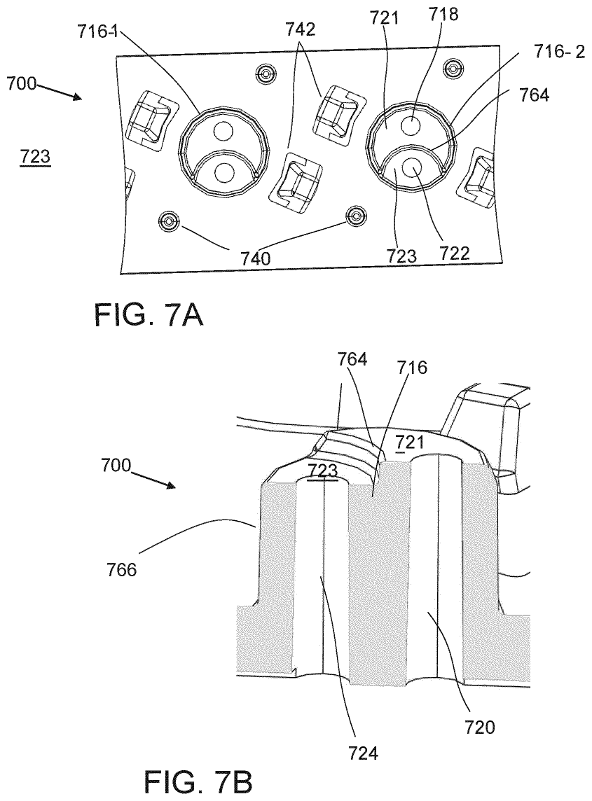

The mixing chamber 104 is formed when the cap 102 is coupled to the base 116. In some embodiments, the base 116 includes alignment pins and attachment clips to orient and secure the cap 102 to the base 116. Alignment pins and attachment clips are described in more detail in connection with FIG. 7A.

The mixing chamber 104 can have a mixing chamber height 108 of about 0.25 mm to about 3.5 mm. For example, the mixing chamber height can be about 0.25 mm to about 3.5 mm, about 0.50 mm to about 3.5 mm, about 0.75 mm to about 3.5 mm, about 1.00 mm to about 3.5 mm, about 1.25 mm to about 3.5 mm, about 1.50 mm to about 3.5 mm, about 1.75 mm to about 3.5 mm, about 2.0 mm to about 3.5 mm, about 2.25 mm to about 3.5 mm, about 2.50 mm to about 3.5 mm, or about 2.75 mm to about 3.5 mm. In some embodiments, it can be advantageous for the length of the stirrer element to be less than the height of the chamber. For example, the stirrer element can go into a vertical orientation within the chamber and get stuck if the length of the stirrer element is greater than the height of the chamber.

The mixing chamber 104 can have a mixing chamber diameter 110 of about 1.0 mm to about 6.0 mm. For example, the mixing chamber 104 can have a mixing chamber diameter 110 of about 1.0 mm to about 6.0 mm, about 1.25 mm to about 6.0 mm, about 1.50 mm to about 6.0 mm, about 1.75 mm to about 6.0 mm, about 2.0 mm to about 6.0 mm, about 2.25 mm to about 6.0 mm, about 2.50 mm to about 6.0 mm, about 2.75 mm to about 6.0 mm, about 3.0 mm to about 6.0 mm, about 3.25 mm to about 6.0 mm, about 3.50 mm to about 6.0 mm, about 3.75 mm to about 6.0 mm, about 4.0 mm to about 6.0 mm, about 4.25 mm to about 6.0 mm, about 4.50 mm to about 6.0 mm, about 4.75 mm to about 6.0 mm, about 5.0 mm to about 6.0 mm, about 5.25 mm to about 6.0 mm, about 5.50 mm to about 6.0 mm, or about 5.75 mm to about 6.0 mm.

The cap 102 can include PCR reagents. For example, the cap 102 can include phase-change PCR reagents. In some embodiments, the phase-change PCR reagents are dried reagents. In some embodiments, the phase-change PCR reagents are lyophilized reagents. In some embodiments, the phase-change PCR reagents are a lyophilized reagent cake. In some embodiments, the lyophilized reagent cake includes the stirrer element 106 that is immobilized.

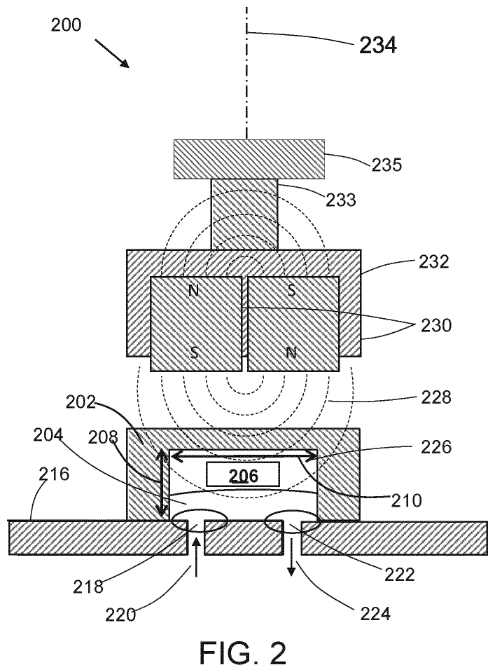

The inlet channel 120 can provide liquid to the mixing chamber 104 via the inlet opening 118 to rehydrate the lyophilized reagent cake. For example, a liquid containing a sample to be tested by the PCR reaction can flow through the inlet channel 120 through the inlet opening 118 and rehydrate the lyophilized reagent cake. When the lyophilized reagent cake is rehydrated, the stirrer element 106 is able to move via application of a magnetic field. The movement of the stirrer element 106 is discussed in greater detail in connection with FIG. 2.

FIG. 1B shows an example of a mixing chamber containing a stirrer element 106. In some embodiments, the features of FIG. 1B include one or more features of the reaction cartridge 100 of FIG. 1A. The mixing chamber 104 of FIG. 1B illustrates the circumference of the mixing chamber 104 is formed by the interior of the cap 102 (of FIG. 1A). In some embodiments, the lyophilized reagent cake would occupy a portion of the mixing chamber and immobilize the stirrer element 106. The lyophilized reagent cake is described in more detail in connection with FIG. 2. The mixing chamber 104 can have analogous dimensions for the mixing chamber height 108 and the mixing chamber diameter 110 as described in connection with FIG. 1A. The stirrer element 106 can have analogous dimensions for the stirrer diameter 114 and stirrer length 112 as described in connection with FIG. 1A.

FIG. 2 shows a cross-section of a mixing chamber 204 containing a stirrer element 206 immobilized in a solid phase-change material 226 and a magnetic driver head 232. In some embodiments, the features of FIG. 2 include one or more features of FIGS. 1A and 1B. FIG. 2 shows a reaction cartridge 200 having a cap 202, a mixing chamber 204, a base 216, an inlet channel 220 having an inlet opening 218, an outlet channel 224 having an outlet opening 222, and a stirrer element 206. The cap 202 forms the chamber 204 when coupled to the base 216. The cap 204 can provide the chamber 204 with a chamber height 208 and a chamber diameter 210 (e.g., analogous to chamber height 108 and chamber diameter 110 of FIG. 1A). In some embodiments, the stirrer element 206 is immobilized in phase-change material 226. FIG. 2 shows drive magnets 230 coupled to a magnetic driver head 232. The magnetic driver head 232 can be coupled to a rotatable shaft 233. The rotatable shaft 233 can be connected to a motor 235. In some embodiments, the rotatable shaft 233 can be coupled to a drivetrain and the drivetrain can be coupled to a motor 235.

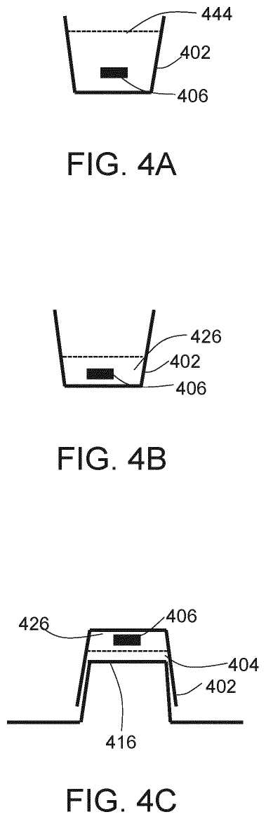

The phase-change material 226 material can be a lyophilized reagent cake. In some embodiments, the lyophilized reagent cake 226 is hydrophilic. In some embodiments, the lyophilized reagent cake 226 is porous. The formation of the phase-change material 226 is described in more detail in connection with FIG. 4.

The reagents included in the lyophilized reagent cake 226 can include reagents used in PCR. For example, reagents such as reverse transcriptase, polymerase, nucleotides, salts (e.g., KCl and/or MgCl₂), sugars, amino acids, and/or RNA inhibitors can be included in the lyophilized reagent cake 226.

Reverse transcriptase activity can be provided by one or more distinct reverse transcriptase enzymes (i.e., RNA dependent DNA polymerases), suitable examples of which include, but are not limited to: M-MLV, MuLV, AMV, HIV, ARRAYSCRIPT™, MULTISCRIBE™, THERMOSCRIPT™, and SUPERSCRIPTR: I, II, III, and IV enzymes. “Reverse transcriptase” includes not only naturally occurring enzymes, but all such modified derivatives thereof, including also derivatives of naturally-occurring reverse transcriptase enzymes. The nucleotides included in the lyophilized reagent cake 226 can include dNTPs used to amplify the nucleic acid. For example, dNTPs such as dATP, dTTP, dGTP, and dTTP can be included in the lyophilized reagent cake 226. RNA inhibitors are recombinant enzymes used to inhibit RNase activity (e.g., RNase H). Sugars such as a monosaccharide, a disaccharide, a polysaccharide, or combinations thereof can be included in the lyophilized reagent cake 226.

Optionally, a reference fluorescence dye is included in the lyophilized reagent cake 226. A reference fluorescence dye is an inert additive dye that does not participate in the PCR reaction. Instead the reference fluorescence dye serves as an internal control to confirm adequate reagent delivery and adequate mixing. In this way, a user can troubleshoot potential problems within the PCR reaction. For example, the reference dye provides confirmation that the reagents were rehydrated and/or provided in the correct concentration to each of the four mixing chambers. So if the reference signal is out of bounds (e.g., outside of known upper and lower thresholds), a null result on the assay can be declared rather than a false negative.

In some embodiments, when a liquid sample enters the mixing chamber 204 via the inlet channel 220, the lyophilized reagent cake 226 rehydrates. For example, the lyophilized reagent cake 226 can dissolve or melt, releasing the stirrer element 206 and allowing it to rotate when the drive magnets 230 are rotated. The stirrer element 206 can be driven by a rotatable magnetic driver head 232 that contains a pair of oppositely aligned drive magnets 230 with magnetization parallel to the axis of rotation 234. The pair of drive magnets 230 generate a magnetic field 228 that has a direction substantially perpendicular to the axis of rotation 234 at the location of the stirrer element 206. Compared with a horizontally aligned drive magnet, use of oppositely aligned drive magnets 230 allows the magnetic driver head 232 to have a smaller diameter and larger separation from the stirrer element 206.

In some embodiments, the stirrer element 206 rotates about its center to mix the rehydrated reagents from the lyophilized reagent cake 226. In some embodiments, the stirrer element 206 orbits within the mixing chamber 204 of the reaction cartridge 200. For example, the stirrer element 206 can orbit within the perimeter of mixing chamber 204 (e.g., around the internal circumference of the mixing chamber 104 of FIG. 1B). In some embodiments, the stirrer element 206 has irregular non-periodic motion to mix the rehydrated lyophilized reagent cake.

The use of stirrer elements 206 to mix lyophilised reagents (e.g., lyophilized reagent cake 226) enables faster and consistent mixing following rehydration. In particular, the high viscosity and density of the concentrated portion of an unmixed rehydrated reagent slows passive mixing by diffusion. This methodology of mixing also enables preparation of small volumes of reagents for a reaction, which are otherwise difficult to mix due to the small length scale of the fluid flows and lack of turbulence. Encapsulating the stirrer element 206 in the lyophilized reagent cake 226 enables easier assembly of the lyophilized reagent cake 226, stirrer element 206, and cap 202 onto the base 216 as potential displacement of the stirrer element is constrained. Including the lyophilized reagent cake 226 in the cap 202 can protect the lyophilized reagent cake 226 from damage during assembly and transport.

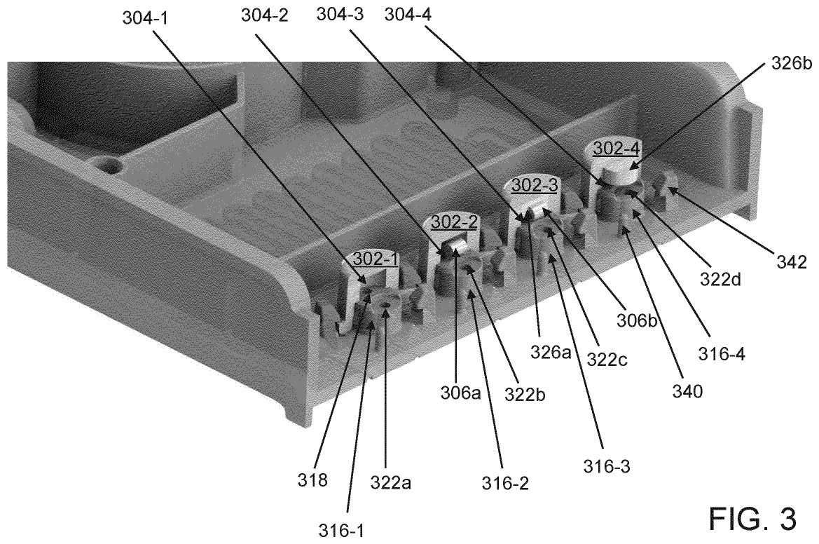

FIG. 3 shows a reaction cartridge system with an array of four mixing chambers. In one embodiment, reaction cartridge system 301 includes one or more features of FIGS. 1A, 1B, and 2. FIG. 3 shows reaction cartridge system 301 with an array of four mixing chambers 304-1, 304-2, 304-3, and 304-4 that are collectively referred to herein as mixing chambers 304 or mixing chamber 304. Each mixing chamber 304 corresponds to a cap. For example, mixing chamber 304-1 is a hollow space within cap 302-1, mixing chamber 304-2 is a hollow space within cap 302-2, mixing chamber 304-3 is a hollow space within cap 302-3, and mixing chamber 304-4 is a hollow space within cap 302-4. The caps are collectively referred to herein as caps 302 or cap 302. The mixing chambers 304 are formed when the caps 302 are coupled or attached to the respective bases. For example, mixing chamber 304-1 is formed when cap 302-1 is coupled to base 316-1, mixing chamber 304-2 is formed when cap 302-2 is coupled to base 316-2, mixing chamber 304-3 is formed when cap 302-3 is coupled to base 316-3, and mixing chamber 304-4 is formed when cap 302-4 is coupled to base 316-4.

Each of the bases 316-1, 316-2, 316-3, and 316-4 include an inlet port with an inlet opening 318 (not visible in mixing chambers 304-2, 304-3, 304-4), and an outlet port with an outlet port opening 322a, 322b, 322c, and 322d. In some embodiments, each mixing chamber 304 can include a stirrer element (e.g., 306a, 306b, or 306c) and a lyophilized reagent cake (e.g., 326a and 326b).

Each of the mixing chambers 304 in FIG. 3 shows a cross-section that shows one of the different assembly stages. For example, the embodiment of mixing chamber 304-1 shows the cap 302-1 coupled to the base 316-1 without a stirrer element and without a lyophilized reagent cake. The embodiment of mixing chamber 304-2 shows the cap 302-2 coupled to the base 316-2 with a stirrer element 306-2 and without a lyophilized reagent cake. The embodiment of mixing chamber 304-3 shows the cap 302-3 coupled to the base 316-3 with a stirrer element 306b embedded in a lyophilized reagent cake 326a. In this embodiments, the lyophilized reagent cake 326a is shown as a cross-section such that the stirrer element 306b is visible. The embodiment of mixing chamber 304-4 shows the cap 302-4 coupled to the base 316-4 with a stirrer element embedded in a lyophilized reagent cake 326b, concealing the stirrer element within.

The inlet opening (e.g., inlet opening 318) is positioned under the lyophilized reagent cake 326b such that when liquid enters the mixing chamber 304-1 via the inlet opening, the lyophilized reagent cake 326b is dissolved releasing the stirrer element contained within the lyophilized reagent cake 326b. In this embodiment, the outlet opening 322d is further away from the lyophilized reagent cake 326b than the inlet opening. Because the outlet opening 322d is further away from the lyophilized reagent cake 326b than the inlet opening, the liquid entering the mixing chamber 304-4 via the inlet channel will fill the mixing chamber 304-4 and dissolve the lyophilized reagent cake 326b prior to exiting the mixing chamber 304-4 via the outlet opening 322d.

Each of the bases 316 can include attachment clips and alignment pins to couple the caps 302 to the base 316. For example, alignment pin 340 corresponds to a hole in the caps 302 such that the caps 302 are coupled to the bases 316 in a particular orientation and attachment clips 342 can couple the caps 302 to the bases 316. In some embodiments, the reagents contained in the lyophilized reagent cake 326 are specific to a particular pathogen. In some embodiments, the reagents contained in the lyophilized reagent cake 326 are specific to a different particular pathogen.

For example, the caps 302 can form part of an integrated consumable, each of which contains the reagents within the lyophilized reagent cake 326 to detect a different target. For example, the targets can include bacterial, viral, and fungal species. In some embodiments, the different targets can be: SARS-COV-2, Influenza A, Influenza B, human respiratory syncytial virus, group A streptococcus, measles, and a sample adequacy control (e.g., RNaseP). In some embodiments, instead of or in addition to a sample adequacy control, the caps 302 can include an internal process control.

In some embodiments, each of the four caps 302 can contain lyophilised reagents including primers and probes specific to respective targets. As discussed in connection with FIG. 2, other components of the lyophilised reagent cake 326 can include reverse transcriptase, polymerase, nucleotides, salts, sugars, amino acids and RNA inhibitors, and optionally a reference fluorescence dye.

In some embodiments, within a single cap 302, there may be multiple sets of primers and probes to detect different sequences corresponding to the same pathogen, or multiple pathogens reported as a group. For example, multiple sets of primers and probes targeting different sequences of the same pathogen can increase robustness and cover incidences of genetic variation. The concentrations of enzymes, primers, probes, nucleotides and other reagents may be independently adjusted within each cap. All the probes report on the same fluorescence channel, providing a simplified optical design.

Optionally, in some embodiments, the reference fluorescence dye has excitation and/or emission wavelengths that differ from the probe fluorophore. In one configuration, the reference dye and the probe fluorophore have different excitation wavelengths and common emission wavelengths, allowing a reference dye and probe fluorescence to be distinguished by illuminating sequentially with different wavelengths, and detecting using the same emission filter and photodiode. This can increase efficiency and reduce the size and cost of the optical detection system. For example, the probe and reference dye can both be independently excited, to allow for them to be distinguished, and then a single set of detection optics can be used. This allows for less expensive and less complex optics.

Non-limiting examples of excitation and emission wavelengths include FAM (fluorescein amidites) with an excitation of about 494 nm and an emission wavelength of about 518 nm, ROX Reference dye (glycine conjugate of 5-carboxy-X-rhodamine, succinimidyl ester) with an excitation of about 578 nm and an emission wavelength of about 604 nm, and ATTO 647 (a zwitterionic dye with a net electrical charge of zero) with an excitation of about 646 nm and an emission wavelength of about 664 nm.

In one embodiment, the sample to be tested for pathogens can be split four ways in the cartridge with a portion of the sample being delivered to each of the four caps 302. For example, the sample can be a liquid sample and/or optionally diluted with a liquid (e.g., dH₂O, PBS, etc.) and split into four different portions to be delivered to each of the four caps 302. The sample enters the mixing chamber 304 via the inlet opening 318 and rehydrates the lyophilized reagent cake 326 to free the stirrer element 306, which can then mix the sample and reagents. Following sufficient mixing, the sample and reagent mixture can exit the mixing chamber 304 via the outlet opening 322 to an amplification chamber for RT-PCR. The concentration of the dissolved reagent in the amplification chamber can be checked by measuring the intensity of the reference dye fluorescence.

In some embodiments, the amplification can take place in the cap 302 if suitable thermal cycling and optical detection hardware are provided, instead of moving the reaction liquid to a separate amplification chamber. This provides benefits of simplified liquid handling and reduced consumable size.

In some embodiments, rather than dedicating an individual cap 302 to an internal process control, each cap 302 can contain probe and primer sets for a target and a control, with the target and control reporting on different fluorescence channels. In this case, one more pathogen can be detected and each cap benefits from a control.

In some embodiments, the probe and/or primer set can be printed onto the bases 316 and the caps 302 can each include the same reagents. In yet another embodiment, a single reagent cap 302 (e.g., without primers and probes) could connect to multiple PCR chambers within which target-specific primers, probes and other reagents could be introduced.

FIG. 4A shows a schematic view of a cap 402 containing a stirrer element 406 and reagents 444. FIG. 4B shows a schematic of a cap 402 containing a stirrer element 406 immobilized in a phase-change material 426, e.g., in the form of dried reagents. FIG. 4C shows a schematic of a cap 402 containing a stirrer element 406 immobilized in dried reagents 426 coupled to a base 416. The cap 402 is coupled to the base 416 from above. Said differently, the cap 402 is positioned above the base 416 when the cap 402 is coupled to the base 416. The embodiment shown in FIGS. 4A, 4B, and 4C can include one or more features described in connection with FIGS. 1A, 1B, 2, and 3.

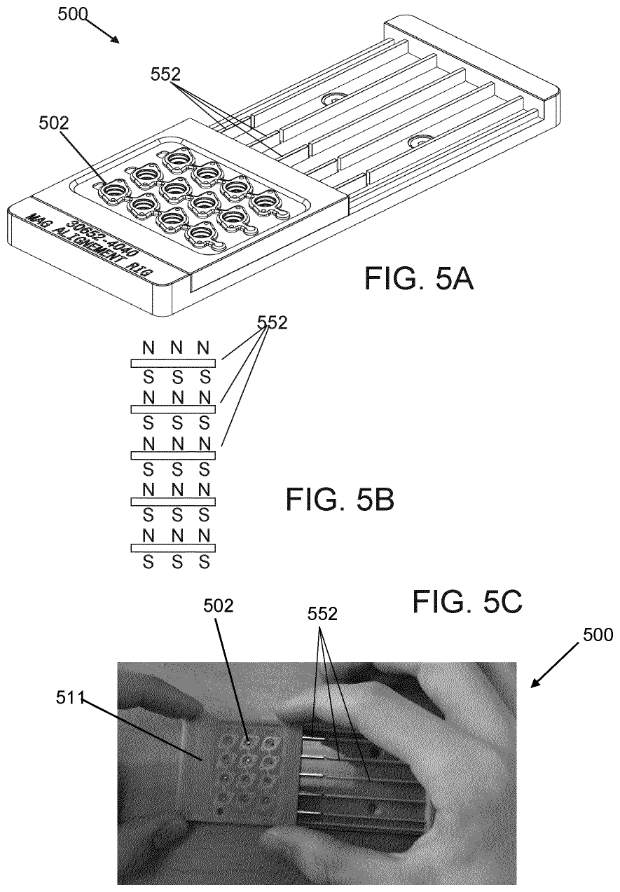

The liquid reagents used in caps 402 can include those suitable for PCR reactions. In some embodiments, the liquid reagents 444 include primers and a probe specific to a pathogen. In some embodiments, the stirrer element 406 is aligned to a particular orientation prior to drying. The alignment of the stirrer element is discussed in further detail in connection with FIGS. 5A-5C. In some embodiments, the liquid reagents 444 of FIG. 4A are dried by lyophilization to produce phase-change material 426 of FIG. 4B. In some embodiments, the liquid reagents 444 of FIG. 4A are dried via vacuum drying to produce phase-change material 426 of FIG. 4B. In some embodiments, the liquid reagents 444 of FIG. 4A are air dried to produce phase-change material 426 of FIG. 4B. In some embodiments, when the cap 402 is coupled to the base 416 a mixing chamber 404 with a smaller volume is formed, allowing the reagent to be reconstituted at a higher concentration than the initial liquid reagent (e.g., liquid reagent 444 of FIG. 4A).

FIG. 5A shows a magnetic alignment fixture or rig 500 used to rotate magnetic stirrer elements with each cap into a horizontal orientation during manufacture of an array or strip that contains multiple caps 502, e.g., four caps are shown in FIG. 5A. FIG. 5B shows the orientation of the alignment magnets 552, e.g., five in number in this example. FIG. 5C shows 12 caps each containing a stirrer element that is aligned by sliding the cap array holder 511 of the alignment fixture 500 over and past the array of alignment magnets 552. In different embodiments, FIGS. 5A, 5B, and 5C can include one or more features described in connection with FIGS. 1A, 1B, 2, 3, 4A, 4B, and 4C.

In some embodiments, the stirrer elements (e.g., stirrer elements 106 of FIGS. 1A and 1B) can be aligned in the liquid reagents (e.g., liquid reagents 444 of FIG. 4A) prior to drying of the liquid reagents to produce a phase-change material (e.g., phase-change material 426 of FIGS. 4B and 4C). Alignment magnets 552 magnetised in their thickness directions, creating horizontal magnetic fields that cause stirrer elements in the caps 502 to align to a horizontal orientation. For example, FIG. 5B shows a schematic of alignment magnets 552 that are magnetized in their thickness directions. In some embodiments, the stirrer elements are aligned in a horizontal orientation prior to immobilization in the phase change material. A horizontal orientation can provide benefits to the reaction cartridge. For example, a horizontal orientation of a stirrer element can allow the stirrer element to spin more freely. In some embodiments, the alignment of the stirrer elements prior to drying can prevent the stirrer element from immobilizing in a vertical position. Immobilization of a stirrer element in a vertical position can prevent the stirrer element from thoroughly mixing the sample and reagents when rehydrated.

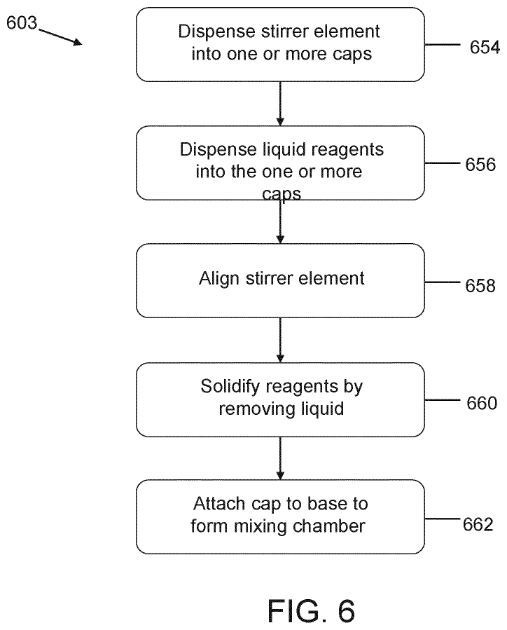

FIG. 6 is a flow chart of assembly steps to create a mixing chamber containing a stirrer element immobilized in a phase-change material. In one embodiment, the systems used to carry out the steps recited in FIG. 6 can include one or more features described in connection with FIGS. 1A, 1B, 2, 3, 4A, 4B, 4C, 5A, 5B, and 5C.

The flow chart 603 describes steps that can take place in this order, out of this order, or simultaneously. In step 654, the stirrer element (e.g., stirrer element 106 of FIGS. 1A and 1B) are dispensed into one or more caps (e.g., caps 402). In step 656, liquid reagents (e.g., liquid reagents 444 of FIG. 4A) are dispensed into one or more caps. Optionally, in step 658, the stirrer element is aligned into a preferred orientation (e.g., horizontal orientation as described in connection with FIGS. 5A, 5B, and 5C). In step 660, the liquid reagent containing the stirrer element is solidified. For example, the liquid reagent can be solidified by freezing and/or evaporating water or solvent components. In one example, the liquid reagent solution is solidified by a freeze-drying process. In step 662, the cap with the solid reagent containing the stirrer element (e.g., the phase-change material 226 of FIG. 2) is coupled to the base (e.g., base 116 of FIG. 1) to form a mixing chamber (e.g., mixing chamber 104 of FIGS. 1A and 1B). The base can include alignment pins (e.g., alignment pins 340 of FIG. 3) to prevent the cap from being attached in an incorrect orientation. The base can further include attachment clips (e.g., attachment clips 242 of FIG. 2).

As mentioned herein, the formation of bubbles can impede efficacy and accuracy of a PCR reaction. The reaction cartridges described herein mitigate the introduction of bubbles to a PCR reaction by arranging inlet and outlet ports and channels on differing planar surfaces, which can introduce a meniscus pinning effect on the liquid sample filling the mixing chamber via the inlet opening of the inlet port.

FIG. 7A is a top view of a reaction cartridge 700 with two bases including a step feature. FIG. 7B is a cross-section of the base of FIG. 7A showing the step feature 764, an inlet channel 720, and an outlet channel 724, separated by a step 764. FIG. 7B shows the base 716 of a mixing chamber including an outlet channel 724, an inlet channel 720, and a step 764. The mixing chamber is formed when a cap is attached to the base 716, forming a fluidic seal on a cap seal surface 766. In one example, the elements in FIGS. 7A and 7B can include one or more features described in connection with FIGS. 1A, 1B, 2, 3, 4A, 4B, 4C, 5A, 5B, 5C, and 6.

The reaction cartridge 700 of FIG. 7A includes base 716 with two alignment pins 740 associated with each base 716-1 and 716-2 (collectively referred to herein as base(s) 716), and two attachment clips 742 associated with each base. Attachment clips 742 and alignment pins 740 allow the caps (e.g., caps 102 of FIGS. 1A and 1B) to be secured to bases 716 to form the mixing chambers (e.g., mixing chamber 104 of FIGS. 1A and 1B) in the hollow space within the caps. In addition, the attachment clips 742 and alignment pins 740 can prevent the caps from being coupled to the base in an incorrect orientation. In this way, an array of caps formed in as a single part can be attached to the base(s) using an array of alignment pins 740 and attachment clips 742. In some embodiments, the attachment clips 742 can couple the cap(s) to the bases to form a seal that can prevent leakage and contamination.

The base 716 further includes outlet opening 722 and inlet opening 718. In some embodiments, the inlet opening 718 is on a first planar surface 721. In some embodiments, the outlet opening 722 is on a second planar surface 723. In some embodiments, the first planar surface 721 is positioned above the second planar surface 723. Said differently, the first planar surface 721 is closer to the cap (e.g., cap 402 of FIG. 4) than the second planar surface 723. In such embodiments, there may be a geometric edge referred to here as step 764. The step 764 can be curved or straight and can be positioned in between or adjacent to the inlet opening 718 and outlet opening 722.

Step 764 can drive liquid flow patterns that increase mixing speed, allowing mixing to take place in a shorter time or with a lower magnetic stirrer rotation speed. The step 764 can provide a meniscus pinning effect that can promote the filling of the mixing chamber via the inlet opening 718 before the liquid exits the mixing chamber via the outlet opening 722. In some embodiments, the liquid delivered to the mixing chamber from the inlet opening 718 will fill the mixing chamber as the step 764 will pin the liquid by its contact line. The liquid will then rehydrate the phase-change material, freeing the stirrer element for mixing. When the contact angle of the liquid on the step 764 increases, the liquid will proceed to fill the remainder of the mixing chamber.

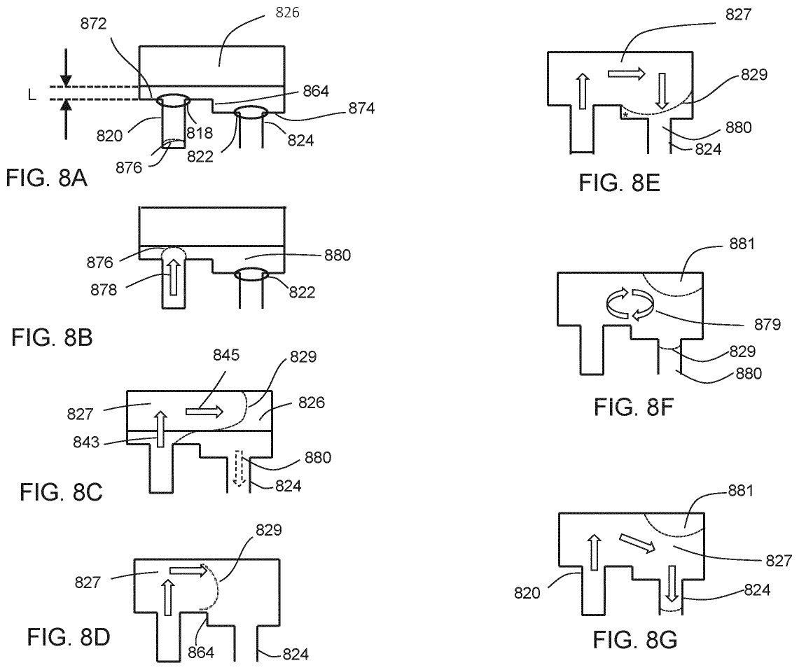

FIG. 8A is a schematic cross-section that shows an initial state of the reaction cartridge with a cap attached to a base. In different embodiments, the elements in FIG. 8A can include one or more features described in connection with FIGS. 1A, 1B, 2, 3, 4A, 4B, 4C, 5A, 5B, 5C, 6, 7A, and 7B. The phase-change material 826 (at the top of the inverted cap) is separated from an inlet opening 818 of the inlet channel 820 by a distance L, and the inlet channel 820 is located in an upper base wall 872 and is closer to the phase-change material 826 than the outlet opening 822 of the outlet channel 824 and at a higher position than the outlet channel 824. FIG. 8A shows a meniscus 876 of a liquid in the inlet channel 820.

Referring still to FIG. 8A, distance L between the inlet opening 818 of the inlet channel 820 and the bottom of the phase-change material 826 can facilitate that an incoming flow of liquid (e.g., liquid sample) contacts the phase-change material 826 before it is able to flow to the outlet channel 824. In some examples, the maximum height of a droplet of liquid forming on the inlet opening 818 of the inlet channel 820 is twice that of the capillary length of water. To avoid the flow of the liquid sample reaching the outlet channel 824 before touching the phase change material 826, the distance L, in some embodiments, is less than twice the capillary length of water. In some embodiments, the distance L is less than the capillary length of water. In some embodiments, the distance L is less than about 5.4 mm. In some embodiments, the distance L is less than about 5.0 mm, less than about 4.5 mm, less than about 4.0 mm, less than about 3.5 mm, less than about 3.0 mm, less than about 2.5 mm, less than about 2.0 mm, less than about 1.5 mm, less than about 1.0 mm, or less than about 0.5 mm. In some embodiments, the distance L is less than about 2.7 mm.

Distance L can be described by the following equation:

$${λ}_{C} = \sqrt{\frac{γ}{g ( {ρ}_{L} - {ρ}_{G} )}} = 2.7 mm ,$$

giving a Bond number:

$$B = \frac{{gL}^{2} ( {ρ}_{L} - {ρ}_{G} )}{γ} ,$$

of less than 1 when calculated using liquid and gas properties of water and air at normal temperature and pressure (NTP) respectively, wherein λ_{C} is the capillary length, γ is the surface tension, g is gravitational acceleration, ρ_{L}−ρ_{G} are the density difference, and L is the characteristic length (i.e., distance L).

FIG. 8B is a schematic cross-section schematic that shows a subsequent state of the reagent rehydration with liquid introduced via an inlet channel within a cap attached to a base. In various embodiments, FIG. 8B can include one or more features described in connection with FIGS. 1A, 1B, 2, 3, 4A, 4B, 4C, 5A, 5B, 5C, 6, 7A, 7B, and 8A.

Referring still to FIG. 8B, in some embodiments, liquid 878 is introduced through the inlet opening (e.g., inlet opening 818 of FIG. 8A) and the meniscus 876 touches the phase-change material 826 before reaching the outlet opening (e.g., outlet opening 822 of FIG. 8A) of the outlet channel (e.g., outlet channel 824 of FIG. 8A). As the liquid 878 flows into the mixing chamber, air can be pushed from the mixing chamber to the outlet channel. The phase change material 826 can be hydrophilic and/or porous to increase the speed of wetting by the liquid 878.

FIG. 8C is a schematic cross-section schematic that shows a subsequent state of the reagent rehydration where the liquid has wet part of the reagent within a cap attached to a base. In various embodiments, FIG. 8C can include one or more features described in connection with FIGS. 1A, 1B, 2, 3, 4A, 4B, 4C, 5A, 5B, 5C, 6, 7A, 7B, 8A, and 8B.

Referring still to FIG. 8C, the liquid (e.g., the liquid 878 of FIG. 8B) has moved vertically as indicated by the arrow 843 and horizontally as indicated by the arrow 845 to wet part of the phase-change material to create rehydrated phase-change material 827 and the advancing liquid front 829 advances within the phase change material 826, while the outlet channel 824 remains dry and gas is expelled from the mixing chamber via the outlet channel 824.

FIG. 8D is another schematic cross-sectional image that shows a subsequent state of the reagent rehydration where the edge of the step feature has caused a meniscus pinning effect on the advancing liquid front 829. In various embodiments, FIG. 8D can include one or more features described in connection with FIGS. 1A, 1B, 2, 3, 4A, 4B, 4C, 5A, 5B, 5C, 6, 7A, 7B, 8A, 8B, and 8C.

Referring still to FIG. 8D, the rehydrated phase-change material 827 and the advancing liquid front 829 has reached the step 864. In some embodiments, the step 864 facilitates a meniscus pinning effect which can promote the liquid (e.g., the liquid 878 of FIG. 8B) to fill the chamber before moving toward the outlet channel 824. In this way, the advancing liquid front 829 is prevented from moving forward when it reaches the geometric edge of the step 864. As liquid continues to fill the chamber, the meniscus formed by the advancing liquid front 829 will overcome the geometric edge created by the step 864 and the rehydrated phase-change material 827 will move toward the outlet channel 824.

FIG. 8E is another schematic cross-sectional image that shows a subsequent state of the reagent rehydration where the reagent has been completely wetted within a cap attached to a base. In various embodiments, FIG. 8D can include one or more features described in connection with FIGS. 1A, 1B, 2, 3, 4A, 4B, 4C, 5A, 5B, 5C, 6, 7A, 7B, 8A, 8B, 8C, and 8D.

Still referring to FIG. 8E, the reagents in the rehydrated phase-change material 827 has been fully wetted by the liquid (e.g., liquid 878 of FIG. 8B). The advancing liquid front 829 advances to the outlet channel 824 expelling gas 880. In some embodiments, gas can be trapped in the lower base wall (marked with an asterisk).

FIG. 8F is another schematic cross-section schematic that shows a subsequent state of the reagent rehydration where the stirrer element is mixing the reagent within a cap attached to a base. In various embodiments, FIG. 8F can include one or more features described in connection with FIGS. 1A, 1B, 2, 3, 4A, 4B, 4C, 5A, 5B, 5C, 6, 7A, 7B, 8A, 8B, 8C, 8D, and 8E.

Still referring to FIG. 8F, a stirrer element (e.g., stirrer element 106 of FIG. 1A), such as a magnetic stirrer element can be used to increase the speed of dissolution and mixing of the rehydrated phase-change material (e.g., rehydrated phase change material 827 of FIG. 8B) within the mixing chamber, and the liquid (e.g., liquid 878 of FIG. 8B) flowing into the inlet channel (e.g., inlet channel 120) is paused during mixing. The advancing liquid front 829 begins to flow into the outlet channel (e.g., outlet channel 824) while the gas 880) continues to exit via the outlet channel. The stirring action can also release trapped air bubbles (marked 30) with as asterisk in FIG. 8E) from the lower base wall and allow them to rise to the upper part of the mixing chamber (marked in FIG. 8F as 881).

FIG. 8G is another schematic cross-sectional image that shows a subsequent state of reagent rehydration within a cap attached to a base when the reagent solution is expelled through an outlet channel. In various embodiments, FIG. 8G can include one or more features described in connection with FIGS. 1A, 1B, 2, 3, 4A, 4B, 4C, 5A, 5B, 5C, 6, 7A, 7B, 8A, 8B, 8C, 8D, 8E, and 8F.

Still referring to FIG. 8G, the flow of liquid into the inlet channel 820 resumes and rehydrated phase change material 827 is expelled through the outlet channel 824 in the lower base wall, while trapped gas bubbles 881 are retained within the mixing chamber.

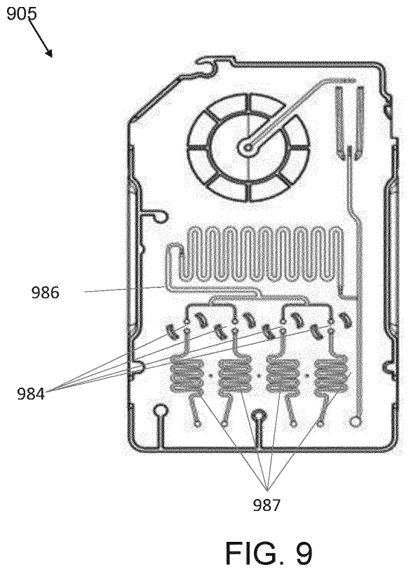

FIG. 9) shows an example of a reaction cartridge. In various embodiments, the cartridge shown in FIG. 9 can include one or more features described in connection with FIGS. 1A, 1B, 2, 3, 4A, 4B, 4C, 5A, 5B, 5C, 6, 7A, 7B, 8A, 8B, 8C, 8D, 8E, 8F, and 8G. Reaction cartridge 905 includes space for an array of four caps (e.g., cap 102 of FIG. 1) as indicated by 984. In this embodiment, fluid intake manifold 986 splits the liquid sample into four channels. The liquid sample can be distributed to each of the cap locations to rehydrate the phase-change material (e.g., phase-change material 226 of FIG. 2) via the inlet mixing chambers (e.g., inlet channel 220 of FIG. 2). After mixing as described in FIG. 8F, the rehydrated phase-change material (e.g., rehydrated phase-change material 827 of FIG. 8C) can move to the amplification mixing chambers (or channels) 987.

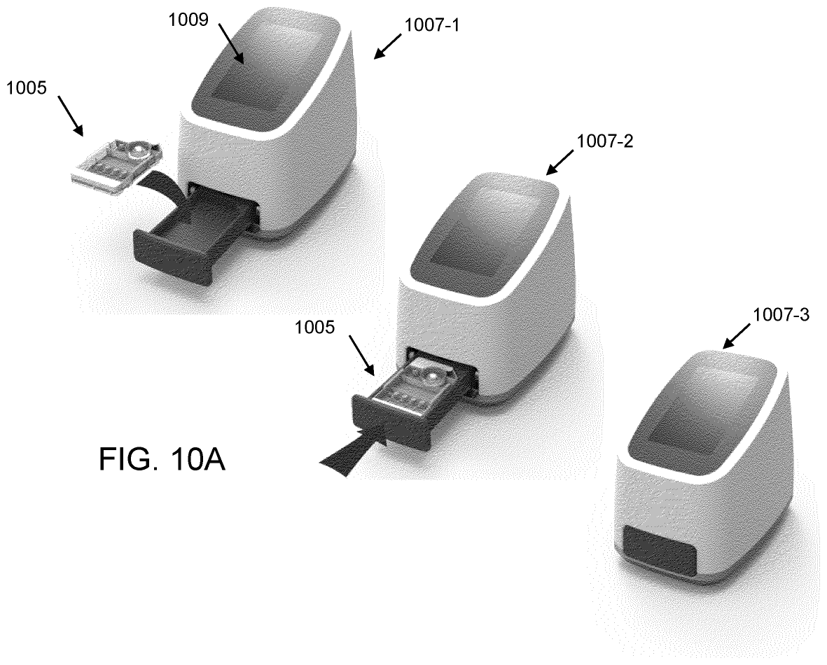

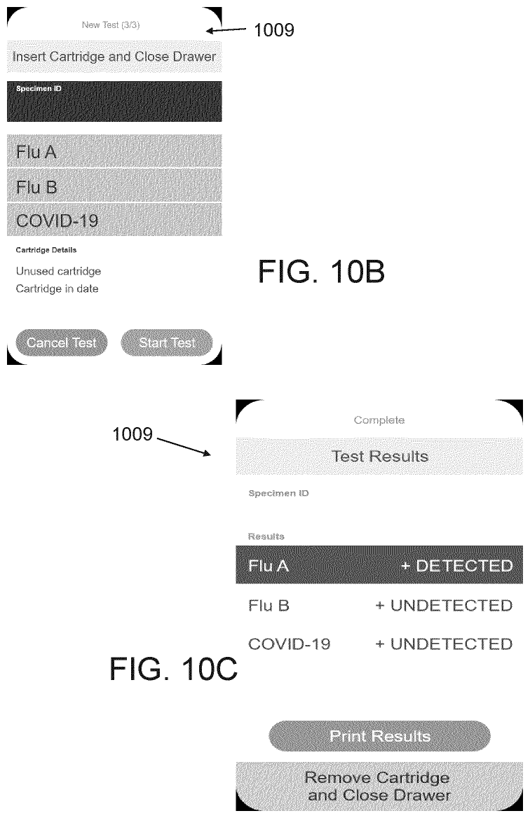

FIG. 10A is an example of loading a reaction cartridge into a PCR reader module 1007-1, 1007-2, 1007-3 (collectively referred to herein as reader module(s) 1007). In various embodiments, FIG. 10A can include one or more features described in connection with FIGS. 1A, 1B, 2, 3, 4A, 4B, 4C, 5A, 5B, 5C, 6, 7A, 7B, 8A, 8B, 8C, 8D, 8E, 8F, 8G, and 9.

Reader module 1007 can include a heater controller for selectively controlling the heater element between an on condition and an off condition in response to the determined temperature of the heater element and/or test sample; and an electrical heater interface for connecting the heater controller and the heater. The reader module can provide a user with control to modify the temperature of the reaction cartridge 1005.

In some embodiments, an example user interface 1009 is visible as an interactive screen on the front of the reader module 1007. A user can, in some examples, utilize the user interface 1009 to program PCR reaction conditions and to interpret results. Reader module 1007-1 is shown with a drawer open such that a reaction cartridge 1005 can be loaded into the reader module 1007-1. Reader module 1007-2 is shown with a drawer open with the reaction cartridge 1005 loaded into the reader module 1007-2. Reader module 1007-3 is shown with a drawer closed such that the reaction cartridge 1005 is inside the reader module 1007-3. A user can then operate the reader module 1007-3 from the user interface 1009.

FIG. 10B is an example of a user interface 1009 of a reader module when operating a reader module in cartridge 1005-1. Each of the three pathogens listed, Flu A, Flu B, and Covid-19, correspond to a different physical location on the reaction cartridge.

FIG. 10C shows an example of PCR results on the user interface of this example. The user interface 1009 can indicate a positive or negative result for the pathogens tested. The pathogens each correspond to a particular location of a cap on the reaction cartridge location.

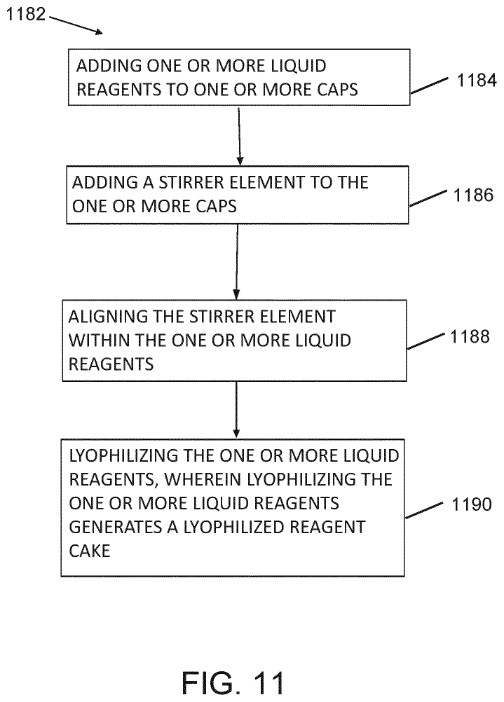

FIG. 11 is an example of a method of making a reaction cartridge. The systems used to carry out the method recited in FIG. 11 can include one or more features described in connection with FIGS. 1A, 1B, 2, 3, 4A, 4B, 4C, 5A, 5B, 5C, 6, 7A, 7B, 8A, 8B, 8C, 8D, 8E, 8F, 8G, 9, 10A, 10B, and 10C. In step 1184, method 1182 includes adding one or more liquid reagents to one or more caps. For example, each cap of the one or more caps can include reagents directed to the detection of a particular pathogen. In some embodiments, the pathogens to be detected are viral pathogens or bacterial pathogens. The liquid reagents can include those suitable for PCR reactions. In some embodiments, the liquid reagents include primers and a probe specific to the pathogen.

In step 1186, method 1182 includes adding a stirrer element to one or more caps. For example, the stirrer element can be a cylinder, a cuboid, a disc, a pyramid, or an irregular geometric shape. In some embodiments, the stirrer element is a cuboid. In some embodiments, the stirrer element is a cylinder. In some embodiments, the stirrer element can have a stirrer length of about 0.75 mm to about 6 mm.

In step 1188, method 1182 includes aligning the stirrer element within the one or more liquid reagents. In some embodiments, the stirrer elements can be aligned in the liquid reagents prior to drying of the liquid reagents to produce a phase-change material. In some embodiments, the stirrer elements are aligned in a horizontal orientation prior to immobilization in the phase change material. A horizontal orientation can provide benefits to the reaction cartridge. For example, a horizontal orientation of a stirrer element can allow the stirrer element to spin more freely. In some embodiments, the alignment of the stirrer elements prior to drying can prevent the stirrer element from immobilizing in a vertical position. Immobilization of a stirrer element in a vertical position can prevent the stirrer element from thoroughly mixing the sample and reagents when rehydrated.

In step 1190, method 1182 includes lyophilizing the one or more liquid reagents, wherein lyophilizing the one or more reagent generates a lyophilized reagent cake. In some embodiments, the liquid reagents containing the stirrer element is solidified. Optionally, instead of lyophilization, the liquid reagent can be solidified by evaporating water or solvent components. In one example, the liquid reagent solution can be solidified by a freeze-drying process. The cap with the solid reagent containing the stirrer element is coupled to the base to form a chamber. The base can include alignment pins to prevent the cap from being attached in an incorrect orientation. The base can further include attachment clips.

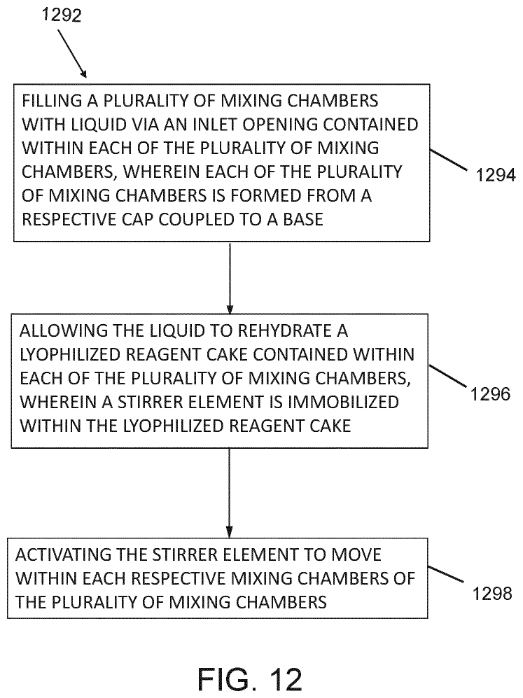

FIG. 12 is an example of a method of filling mixing chamber to rehydrate reagents and mitigate bubbles. The systems used to carry out the method recited in FIG. 12 can include one or more features described in connection with FIGS. 1A, 1B, 2, 3, 4A, 4B, 4C, 5A, 5B, 5C, 6, 7A, 7B, 8A, 8B. 8C, 8D, 8E, 8F, 8G, 9, 10A, 10B, 10C, and 11.

In step 1294, method 1292 includes filling a plurality of mixing chambers with liquid via an inlet opening contained within each of the plurality of mixing chambers, wherein each of the plurality of mixing chambers is formed from a respective cap coupled to a base. In some embodiments, a distance L between the inlet opening of the inlet channel and the bottom of the phase-change material can facilitate that an incoming flow of liquid (e.g., liquid sample) contacts the phase-change material before it is able to flow to the outlet channel. In step 1296, method 1292 includes allowing the liquid to rehydrate a lyophilized reagent cake contained within each of the plurality of mixing chambers, wherein a stirrer element is immobilized within the lyophilized reagent cake. In some embodiments, liquid is introduced through the inlet opening and the meniscus touches the phase-change material before reaching the outlet opening of the outlet channel. As the liquid flows into the mixing chamber, air can be pushed from the mixing chamber to the outlet channel. The phase change material can be hydrophilic and/or porous to increase the speed of wetting by the liquid.

In step 1298, method 1292 includes activating the stirrer element to move within each respective mixing chamber of the plurality of mixing chambers. In some embodiments, when the liquid enters the mixing chamber via the inlet channel, the lyophilized reagent cake rehydrates. For example, the lyophilized reagent cake can dissolve or melt, releasing (e.g., activating) the stirrer element and allowing it to rotate when drive magnets are rotated. The stirrer element can be driven by a rotatable magnetic driver head that contains a pair of oppositely aligned drive magnets with magnetization parallel to the axis of rotation. The pair of drive magnets generate a magnetic field that has a direction substantially perpendicular to the axis of rotation at the location of the stirrer element. Compared with a horizontally aligned drive magnet, use of oppositely aligned drive magnets allows the magnetic driver head to have a smaller diameter and larger separation from the stirrer element.

### EXAMPLES

### Example 1: Analytical Approximation of Cylinder Aspect Ratio for Magnetic Stirrer Constrained to Fit within a Unit Radius Circle

Model calculations to calculate axial and transverse shape factors from an approximation as described in Prozorov, Ruslan & Kogan, V. (2018). Effective Demagnetizing Factors of Diamagnetic Samples of Various Shapes. Physical Review Applied. 10. 10.1103/PhysRevApplied. 10.014030, which is incorporated by reference in its entirety, can be used to determine the best shape and size for a stirrer element given a specific sized and shaped mixing chamber.

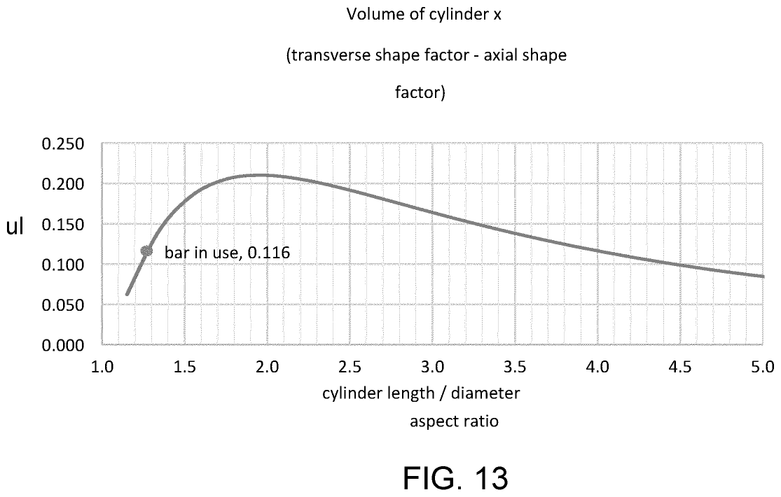

FIG. 13 is a graph showing a figure of merit for cylindrical stirrer elements plotted against cylinder aspect ratio (length to diameter) in the range 1.15 and 5.0 and subject to the constraint that the stirrer element can rotate within a 1 mm radius circle. The figure of merit is calculated as the volume of the cylinder (in mm³) multiplied by the difference between axial and transverse shape factors, as defined in equations 24 and 27 of Prozorov, Ruslan & Kogan, V. (2018). Effective Demagnetizing Factors of Diamagnetic Samples of Various Shapes. Physical Review Applied. 10. 10.1103/PhysRevApplied. 10.014030, which is incorporated herein in its entirety. This figure of merit is proportional to the torque that can be applied to a cylindrical stirrer element by a rotating magnetic field, with a larger value indicating a preferred stirrer element design. The graph shows an example of cylindrical stirrer element that has a length of 2.46 mm, diameter of 1.93 mm, an aspect ratio of 1.26, and a figure of merit of 0.116 mm³.

The analytical approximation of cylinder aspect ratio for the stirrer element can be seen in Table 1, below.

TABLE 1

| | cyl | | | | | | volume |
|---|---|---|---|---|---|---|---|
| cyl | half- | cyl | length/ | | | N_transverse − | (transverse − |
| radius, a | length, b | volume | diameter | N_axial | N_transverse | N_axial | axial) |
| 0.190 | 0.982 | 0.223 | 5.167 | 0.108 | 0.468 | 0.360 | 0.080 |
| 0.209 | 0.978 | 0.268 | 4.679 | 0.118 | 0.465 | 0.347 | 0.093 |
| 0.230 | 0.973 | 0.323 | 4.233 | 0.129 | 0.461 | 0.333 | 0.108 |
| 0.253 | 0.967 | 0.389 | 3.826 | 0.140 | 0.458 | 0.317 | 0.123 |
| 0.278 | 0.961 | 0.467 | 3.453 | 0.153 | 0.454 | 0.300 | 0.140 |
| 0.306 | 0.952 | 0.560 | 3.111 | 0.167 | 0.449 | 0.282 | 0.158 |
| 0.337 | 0.942 | 0.670 | 2.798 | 0.183 | 0.444 | 0.261 | 0.175 |
| 0.370 | 0.929 | 0.800 | 2.509 | 0.199 | 0.438 | 0.239 | 0.191 |
| 0.407 | 0.913 | 0.952 | 2.242 | 0.218 | 0.432 | 0.214 | 0.204 |
| 0.448 | 0.894 | 1.127 | 1.996 | 0.238 | 0.425 | 0.186 | 0.210 |
| 0.493 | 0.870 | 1.328 | 1.766 | 0.261 | 0.417 | 0.155 | 0.206 |
| 0.542 | 0.840 | 1.552 | 1.550 | 0.287 | 0.407 | 0.120 | 0.186 |
| 0.596 | 0.803 | 1.793 | 1.346 | 0.317 | 0.396 | 0.079 | 0.142 |
| 0.656 | 0.755 | 2.041 | 1.151 | 0.352 | 0.382 | 0.031 | 0.062 |
| 0.619* | 0.786* | 1.889* | 1.270* | 0.330* | 0.391* | 0.061* | 0.116* |

*indicates example values for a stirrer element.

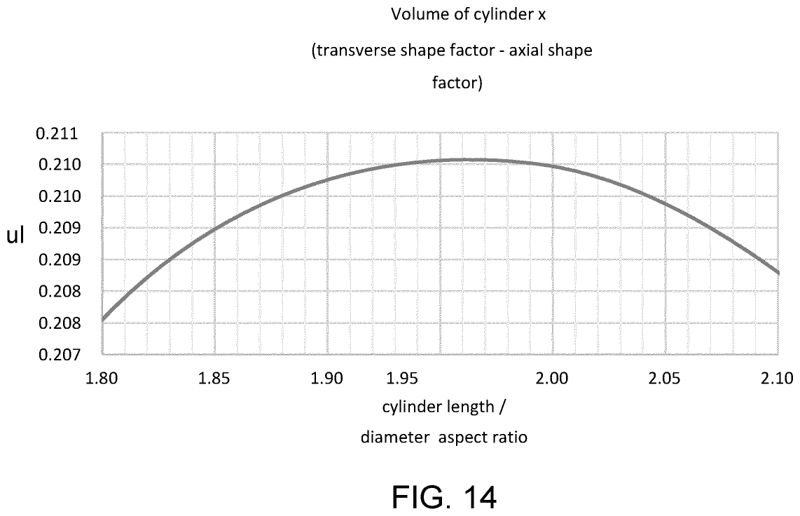

FIG. 14 is a graph that shows an example of a ratio (length to diameter) of a stirrer element with a narrowed range around the peak of FIG. 13.

When an external magnetic field is applied, a cylindrical magnetic stirrer experiences a torque acting to align the cylinder axis parallel to the magnetic field. The torque experienced by the stirrer is proportional to the volume of the stirrer element and also depends on its aspect ratio. The cylinder is more strongly magnetized when it has its axis aligned with the magnetic field and is less strongly magnetized when it has its axis perpendicular to the magnetic field. The difference in magnetization determines the torque and is proportional to the difference in the axial and transvers demagnetizing factors. To maximize the torque on the stirrer, it is important to maximize the product of the stirrer volume and the difference between the perpendicular and axial demagnetizing factors. In this case the optimum value of the cylinder aspect ratio is calculated to be 1.95 using an analytical method and 2.35 using a finite element simulation method, where the length and diameter of the cylinder are constrained to allow rotation within a 1 mm radius cylinder.

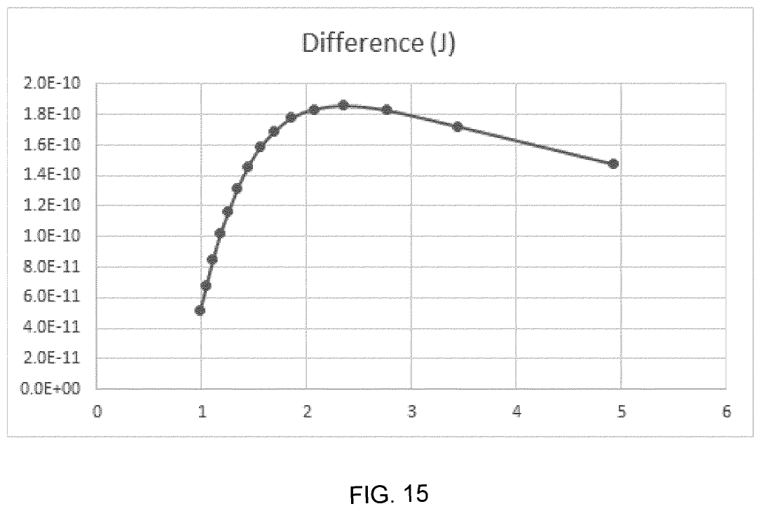

FIGS. 13 and 14 show an analytical approach where the torque is estimated using a simplified analytical expression as described in Prozorov et al. FIG. 15 uses an alternative approach, in which a finite element simulation is used to evaluate the difference in magnetization energy when a magnetic field is applied in axial vs transverse directions. This gives a qualitatively similar result with the optimum aspect ratio of 2.35.

FIG. 15 is a graph of a calculation of a numerical simulation of the difference in magnetic energy using COMSOL Multiphysics® software, the x-axis is the dimensionless ratio of the length of a cylinder/diameter of a cylinder and the y-axis is the difference in total magnetic energy in Joules between the case when a magnetic field is applied in a direction perpendicular to the axis of the cylinder and the case when a magnetic field is applied in a direction parallel to the axis of the cylinder.

Table 2 below shows the values utilized to generate the graph of FIG. 15, which shows the results of numerical simulation calculations used to calculate axial and transverse shape factors from an approximation, as described in Prozorov, Ruslan & Kogan, V., Effective Demagnetizing Factors of Diamagnetic Samples of Various Shapes. Physical Review Applied. 10. 10.1103/PhysRevApplied. 10.014030 (2018), which is incorporated herein by reference in its entirety. These calculations can be used to determine the best shape and size for a stirrer element given a specific sized and shaped mixing chamber.

TABLE 2

| | | | | | Total | Total | |
|---|---|---|---|---|---|---|---|
| | | | | | magnetic | magnetic | |
| l2_cyl | a_cyl | Length | Diameter | | energy (J)- | energy (J)- | Difference |
| (mm) | (mm) | l (mm) | d (mm) | l/d | Angle 0° | Angle 90° | (J) |
| 0.7 | 0.7141428 | 1.40 | 1.43 | 0.98 | 7.85E−09 | 7.80E−09 | 5.21E−11 |
| 0.72 | 0.6939741 | 1.44 | 1.39 | 1.04 | 7.85E−09 | 7.79E−09 | 6.80E−11 |
| 0.74 | 0.6726069 | 1.48 | 1.35 | 1.10 | 7.86E−09 | 7.77E−09 | 8.52E−11 |
| 0.76 | 0.6499231 | 1.52 | 1.30 | 1.17 | 7.86E−09 | 7.76E−09 | 1.02E−10 |
| 0.78 | 0.6257795 | 1.56 | 1.25 | 1.25 | 7.86E−09 | 7.74E−09 | 1.16E−10 |
| 0.8 | 0.6 | 1.60 | 1.20 | 1.33 | 7.86E−09 | 7.73E−09 | 1.32E−10 |
| 0.82 | 0.5723635 | 1.64 | 1.14 | 1.43 | 7.86E−09 | 7.71E−09 | 1.46E−10 |
| 0.84 | 0.5425864 | 1.68 | 1.09 | 1.55 | 7.85E−09 | 7.69E−09 | 1.59E−10 |
| 0.86 | 0.510294 | 1.72 | 1.02 | 1.69 | 7.85E−09 | 7.68E−09 | 1.69E−10 |
| 0.88 | 0.4749737 | 1.76 | 0.95 | 1.85 | 7.84E−09 | 7.66E−09 | 1.78E−10 |
| 0.9 | 0.4358899 | 1.80 | 0.87 | 2.06 | 7.82E−09 | 7.64E−09 | 1.84E−10 |
| 0.92 | 0.3919184 | 1.84 | 0.78 | 2.35 | 7.81E−09 | 7.62E−09 | 1.86E−10 |
| 0.94 | 0.3411744 | 1.88 | 0.68 | 2.76 | 7.78E−09 | 7.60E−09 | 1.83E−10 |
| 0.96 | 0.28 | 1.92 | 0.56 | 3.43 | 7.75E−09 | 7.58E−09 | 1.72E−10 |
| 0.98 | 0.1989975 | 1.96 | 0.40 | 4.92 | 7.71E−09 | 7.56E−09 | 1.48E−10 |

a_cyl is the radius of the cylinder.
l_cyl is half the cylinder length.
l/d is the aspect ratio of the cylinder.

### OTHER EMBODIMENTS

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1-18. (canceled)

19. A reaction cartridge system, comprising:
one or more caps, each cap comprising:
a lyophilized reagent cake within the one or more caps; and
a stirrer element encapsulated within the lyophilized reagent cake;
a base, comprising:
one or more inlet channels having an inlet opening positioned on a first planar surface on the base; and
one or more outlet channels having an outlet opening positioned on a second planar surface the base, wherein:
the first planar surface is positioned above the second planar surface when the reaction cartridge system is in use;
the one or more caps are coupled to the base to form one or more mixing chambers such that the lyophilized reagent cake of each cap of the one or more caps is positioned above a respective one or more inlet channels within the mixing chamber;
the one or more outlet channels and the one or more inlet channels extend through the base; and
prior to use, a reaction volume is enclosed within a hollow space of each of the one or more caps when the one or more caps are coupled to the base.

20. The reaction cartridge system of claim 19, wherein the inlet channel and the outlet channel extend generally orthogonally respective to the base of the one or more mixing chambers.

21. The reaction cartridge system of claim 19, wherein the one or more reaction cartridges are arranged on a pitch of about 0.5 mm to about 15 mm.

22. (canceled)

23. The reaction cartridge system of claim 19, wherein a distance between the inlet opening of the one or more inlet channels and the lyophilized reagent cake within the cap is less than the capillary length of water.

24. The reaction cartridge system of claim 19, wherein a distance L between the inlet opening and a lower surface of the lyophilized reagent cake is less than the capillary length λ_{C}:
$${λ}_{C} = √ ( γ / ( g ( {ρ}_{L} - {ρ}_{G} ) ) ) = 2.7 mm ,$$
giving a Bond number Bo=(g L²(ρ_{L}−ρ_{G}))/γ
of less than 1 when calculated using liquid and gas properties of water and air, respectively, at normal temperature and pressure (NTP) respectively, wherein λ_{C} is the capillary length, γ is surface tension, g is gravitational acceleration, and ρ_{L}−ρ_{G} is density difference.

25-26. (canceled)

27. The reaction cartridge system of claim 19, wherein the lyophilized reagent cake of each of the one or more caps comprises one or more reagents for a polymerase chain reaction.

28-29. (canceled)

30. The reaction cartridge system of claim 19, wherein one or more probes are included in the lyophilized reagent cake of each of the one or more caps, and wherein each of the one or more probes correspond to a position of the respective one or more caps coupled to the one or more mixing chambers.

31-33. (canceled)

34. The reaction cartridge system of claim 30, wherein the lyophilized reagent cake of each of the one or more caps includes a reference dye, and wherein an excitation wavelength of the reference dye is at a different excitation wavelength than the excitation wavelength of the one or more probes.

35-36. (canceled)

37. The reaction cartridge system of claim 34, wherein the reference dye is visible at the same emission wavelength as the one or more probes when the one or more inlet channels fills their respective mixing chamber with liquid.

38. (canceled)

39. The reaction cartridge system of claim 34, wherein the reference dye is a glycine conjugate of 5-carboxy-X-rhodamine, succinimidyl ester.

40-43. (canceled)

44. The reaction cartridge system of claim 19, further comprising one or more driving magnets positioned above the one or more caps.

45. A method of making a reaction cartridge, the method comprising:
a) adding one or more liquid reagents to one or more caps;
b) adding a stirrer element to the one or more caps;
c) aligning the stirrer element within the one or more liquid reagents; and
d) lyophilizing the one or more liquid reagents to generate a lyophilized reagent cake, wherein the stirrer element is immobilized in the lyophilized reagent cake.

46. (canceled)

47. The method of claim 45, further comprising, prior to d), adding one or more primers and corresponding probes to each of the one or more caps.

48. The method of claim 47, wherein the one or more primers and corresponding probes added to each of the one or more caps are different.

49. The method of claim 45, wherein c) comprises applying a magnetic field in a direction substantially perpendicular to the one or more caps.

50. The method of claim 45, further comprising, prior to d), adding a reference dye to the one or more caps.

51-53. (canceled)

54. A method of rehydrating a lyophilized reagent cake contained within a reaction cartridge, the method comprising:
a) filling a plurality of mixing chambers with liquid via an inlet opening contained within each of the plurality of mixing chambers, wherein each of the plurality of mixing chambers is formed from a respective cap coupled to a base;
b) allowing the liquid to rehydrate a lyophilized reagent cake contained within each of the plurality of mixing chambers, wherein a stirrer element is immobilized within the lyophilized reagent cake; and
c) activating the stirrer element to move within each respective mixing chamber of the plurality of mixing chambers.

55. (canceled)

56. The method of claim 54, wherein the lyophilized reagent cake comprises reagents for PCR.

57. The method of claim 54, wherein activating the stirrer element comprises applying a magnetic field to the stirrer element.

58. (canceled)

59. The method of claim 57, wherein applying the magnetic field to the stirrer element causes the stirrer element to rotate and to move around a perimeter of the respective mixing chamber of the plurality of mixing chambers.
